(19) United States
(12) Patent Application Publication
(10) Pub. No.: US 2010/0210254 A1
(43) Pub. Date: Aug. 19, 2010

(54) System and Method for Regulating Mobile Communications Use by Drivers

(76) Inventors: Charles Kelly, New Berlin, WI (US); John Looby, New Berlin, WI (US)

Correspondence Address: BOYLE FREDRICKSON S.C., 840 North Plankinton Avenue, MILWAUKEE, WI, 53203, US

(21) Appl. No.: 12/703,304

(22) Filed: Feb. 10, 2010

Related U.S. Application Data
(63) Continuation-in-part of application No. 12/404,882, filed on Mar. 16, 2009.
(60) Provisional application No. 61/152,655, filed on Feb. 13, 2009.

(51) Int. Cl. H04M 3/00; G06F 7/00; G01S 19/24; G06F 17/30

(52) U.S. Cl. 455/418; 701/33; 342/357.07; 707/802; 707/E17.044

(57) ABSTRACT

The present invention relates to a system for regulating use of mobile communication functions while driving. The system includes a vehicle diagnostic device configured to generate vehicle diagnostic data indicating a current state of a vehicle, a vehicle diagnostic information port configured to provide the vehicle diagnostic data, a transceiver configured to plug into the vehicle diagnostic information port and transmit the vehicle diagnostic data using a wireless communication protocol; and a vehicle responsive phone including communication blocking software configured to receive the vehicle diagnostic data and to terminate the operation of at least one function of the vehicle responsive phone based on the received vehicle diagnostic data.

### CROSS REFERENCE TO RELATED APPLICATIONS

This application is a Continuation-in-Part Application which claims priority to U.S. Provisional Patent Application No. 61/152,655 filed Feb. 13, 2009, and U.S. Non-Provisional patent application Ser. No. 12/404,882 filed Mar. 16, 2009, hereby incorporated by reference.

### FIELD OF INVENTION

The present invention relates to the field of systems and methods used to regulate use of mobile communication devices by drivers while a vehicle is in motion.

### BACKGROUND

Mobile communication devices present a deadly visual distraction to drivers. The risk of a collision increases by more than 23 times when a driver picks up a cell phone and/or sends a text message. Numerous states have passed or are in the process of evaluating legislation to ban texting and regulate other visual distractions from electronic devices. Criminal prosecutions for injuries caused by use of texting, e-mail and telephonic services are frequently reported.

There are multiple devices known in the art which are used to capture information about the motion of a vehicle. While it is generally agreed that mobile communication services provide a deadly distraction, there is not yet a reliable system in the prior art which makes it economically feasible to monitor and restrict driving/mobile communication behaviors. For example, monitoring such use by mobile communication carriers who provide and program telephonic equipment can result in decreased cell phone use and revenue loss for these companies. Further, mobile communication devices generally have “hidden” proprietary application interfaces which make it difficult for third party vendors and programmers to develop solutions for regulating use of equipment by drivers.

Many devices known in the prior art for monitoring driver behavior rely on costly GPS technology, which currently is available on many mobile communications devices. For example, U.S. Pat. No. 7,705,784 (“Barbera '784”) contemplates an apparatus for disabling cell phone functionality which utilizes data captured by a GPS component within a mobile communication device to monitor vehicle speed. However, GPS applications which detect motion and shut off a device require that the mobile communication device include GPS functionality, a feature that is not universally included.

Additionally, reliance on the GPS technology can make the mobile communication device itself unreliable in other situations. For example, when a user is on public transportation (e.g., a train or bus), a mobile communication device might shut down because the mobile communication functionality is not responding to data from a specific vehicle, but rather to changes in position of the user's phone.

On-board diagnostic devices (OBDs) and/or other vehicle diagnostic devices can provide data (such as OBD data) regarding various states of a vehicle, but are not configured in the prior art to interact with the operating systems of mobile communications devices to cause the devices to shut-off distracting functions when a vehicle is in motion.

It is desirable to have a mobile communication device which can process OBD data from a specific vehicle and selectively disable text, e-mail, and/or other distracting functions of mobile communication devices.

It is further desirable to have a reliable technology to selectively disable functionality of a mobile communication device which does not depend on the use of GPS satellite transmissions or other functionality external to the automobile.

It is further desirable to have a system for limiting the use of a mobile communication device which does not require equipment to be installed into the transmission, hardwired into the vehicle, or installed in the steering column or other parts of the vehicle.

It is further desirable to implement a system for limiting mobile communication device functionality which is reliable, can sample motion data at appropriate intervals, and is not easily disabled because of limitations inherent to satellite data.

It is further desirable to have a device which can interact with a wide range of mobile communication devices having proprietary or hidden application programming interfaces.

It is further desirable to have a system which makes it economically feasible for mobile communications companies to monitor dangerous driving usage, without a consequent impact on their revenues from loss by reducing minutes for which they can charge users.

It is further desirable to have a proprietary mobile communication device which can be selectively disabled without requiring a user to independently download and configure software components on multiple apparatuses.

It is further desirable to have a system capable of collecting and data relevant to tracking driving behavior and monitoring compliance for safe driving and cell phone usage, which may be used to create revenue, incentive, discount and compliance programs utilizing the captured data.

### GLOSSARY

As used herein, the term “vehicle responsive phone” includes any mobile communications device configured to utilize vehicle diagnostic data to enable and disable mobile communications, including but not limited to, voice, text, e-mail, and/or any other communication protocol or user feature known in the art which may be deployed on a personal communications device. Examples of vehicle responsive phones include, but are not limited to, personal digital assistants (PDAs), pagers, phones, text messaging devices, a Blackberry™, an iPhone™, laptops, electronic organizers and calendars, or any other technology which may be viewed or used to access electronic functions over the Internet or telephone systems and may be viewed or utilised by a user while the user is driving.

As used herein, the term “application programming interface” (“API”) includes computer software configured to allow a user to request services from a mobile communication device operating system and to actuate core mobile device functions. For example, an API may include, but is not limited to, a programming interface used to enable/disable a specific function such as a communication device's ability to send and receive incoming/outgoing calls and text messages. Other exemplary APIs may be used to send messages to a mobile network, monitor user access, identify user actions, implement additional functionality and applications, etc.

As used herein, the term “vehicle diagnostic device” includes any on-board diagnostic system known in the art including OBD, OBD II, other OBD systems, engine control modules, vehicle-mounted GPS systems, integrated GPS systems, computer components of vehicle components, computer systems computer diagnostics, sensors or any other apparatus or system known in the art capable of measuring, sensing or transmitting data about the state of a vehicle or its component parts.

As used herein, the term “vehicle diagnostic data” or “OBD data” includes data about the state of a vehicle obtained from a device that is integral to the vehicle, including but not limited to, an on board diagnostic device, such as OBD or other circuitry and software within a vehicle. For example, data from an OBD can used to determine whether a vehicle is in motion and the speed of a vehicle.

As used herein, the term “vehicle diagnostic transceiver” includes a component which transmits vehicle diagnostic data information received and/or derived from an engine control module or any other device within the vehicle (e.g., an onboard diagnostic computer) to a cell phone. The transceiver can be, but is not limited to, an OBD device installed on the vehicle at the original equipment manufacturing (OEM) level, such as found in vehicles equipped with Bluetooth diagnostic capabilities, or a diagnostic plug-in device. A diagnostic plug-in device is a device which reads OBD data while plugged into an OBDII port and transmits the data via a wireless communication protocol, such as Bluetooth®. This type of device has been used for applications including emissions verification and vehicle service maintenance status. Vehicle diagnostic data includes but is not limited to vehicle speed information, vehicle transmission state information, and/or any other data from a vehicle used as a diagnostic tool.

As used herein, the term “engine control module” or “engine control module interface” means a device which controls and/or provides information about the engine of a vehicle.

As used herein, the term “central data repository” includes a database in which data is maintained about a user, user history, user sessions, compliance, attempted circumvention or any other information relevant to user activity.

As used herein, the term “communication interface” includes but is not limited to a physical interface, a software based interface, and/or any other interface on which audio and/or visual data is displayed or communicated.

As used herein, the term “wireless protocol” includes any other wireless communication protocol, such as Bluetooth™, for exchanging data using wireless communication between fixed and/or mobile devices.

As used herein, the term “OBD” includes any system or method implemented in a vehicle to provide self-diagnostic information. “OBD-II port” includes a physical interface or connection point for an OBD-II device or system.

As used herein, the term “mobile communication device” includes any communication device, such as a cell phone, pager, laptop, messaging device, e-mail device, text transmission device, personal digital assistant (PDA) device, portable printer, GPS, iPod, memory device, etc., configured to send, receive, store or otherwise utilize audio or visual communication data.

As used herein, the term “mobile device identification data” includes any unique or quasi-unique data used to identify a particular mobile communication device or owner of a mobile communication device.

As used herein, the term “network communication capability” means the ability to transmit data over a wireless network.

As used herein, the term “vehicle diagnostic data” includes any data related to a vehicle and capable of being measured, captured, or transmitted using an vehicle diagnostic transmitter or equivalent device.

As used herein, the terms “movement parameter” or “movement parameters” include any measurable data points or comparable data points related to the movement of a vehicle, including vehicle speed, position of the transmission gear (park, reverse, neutral, drive), vehicle faults which would prevent the vehicle from being operated, vehicle air bag deployment codes, etc.

As used herein, the term “predetermined criteria” means criteria or parameters specified within a software design. Predetermined criteria may be used to initiate a function or capability or to limit a function or capability.

### SUMMARY OF INVENTION

The system, method and apparatus described herein controls and monitors use of any mobile communication device for functions such as placing and receiving phone calls, texting, emailing, and/or any other forms of mobile communication based on vehicle diagnostic data, such as OBD or ODB-II data. The invention described herein includes communication blocking software installed on a mobile communications device adapted to receive vehicle diagnostic data from one or more automobile systems. The communication blocking software interacts with the operating system or BIOS (core functionality) of the mobile communications device to disable/enable certain functions of the mobile communication device.

Vehicle diagnostic data may be received and/or generated by a device including a transceiver configured to transmit a signal (using Bluetooth or another functionally equivalent wireless communication protocol) to the mobile communication device including communication blocking software. The device including a transceiver may be an OBD reader that is configured to plug into an OBD port of the vehicle. Alternatively, the device including the transceiver may be an integral component of the vehicle, such as an engine control module that includes a transceiver.

A mobile communication device including communication blocking software that blocks communication based on the vehicle diagnostic data may be a cellular telephone device, such as a smart-phone, referred to hereinafter as a vehicle responsive phone, although any communication device may be used. In one exemplary embodiment, the mobile communication device may include software configured to receive a signal from the OBD receiving/transmitting component. In an exemplary embodiment, the mobile communication device is configured to receive vehicle diagnostic data indicating a movement state of the vehicle. The software for receiving OBD data may be installed during manufacturing and programming of the mobile communication device. The software may be installed in the memory of the phone.

In an exemplary embodiment, the system and method described herein may be configured to disable/enable operation of the communication device based on a message sent to a communication services provider for the communication device. In this embodiment, the communication device and/or some other component, such as the OBD reader including a transceiver, may be further configured to send a message to a cell phone provider when the vehicle is in motion and/or stopped to alert the service provider to interrupt or restore service.

Various embodiments of the mobile communication device described herein may utilize vehicle diagnostic information transmitted via a wireless communications protocol (e.g., Bluetooth™) to a mobile device (PDA, cell phone, laptop, portable printer, GPS, iPod, etc.). When the vehicle diagnostic information (e.g. whether the car is in gear, the speed of the vehicle, etc.) is received by the mobile communication device, the device disables or enables one or more functions of the mobile communications device including, but not limited to, telephone calls, incoming text messages, incoming pager messages, incoming e-mails, outgoing telephone calls, outgoing text messages, outgoing pager messages, outgoing e-mails, audio data and visual data, etc., based on the diagnostic information.

### BRIEF DESCRIPTION OF DRAWINGS

FIG. 1 illustrates an exemplary mobile communication system including a vehicle responsive phone.

FIG. 2 illustrates an exemplary mobile communication system including a central data repository for storing data from a vehicle responsive phone.

FIG. 3 illustrates a further embodiment in which a transceiver may be configured to detect the presence of a vehicle responsive phone and control operation of the phone by interfacing directly with a communication services provider providing the communication services for the phone.

FIG. 4 illustrates an exemplary method for configuring a mobile communication device to receive and respond to vehicle diagnostic data to disable mobile communication device functionality.

FIG. 5 illustrates an embodiment of a mobile communication device system adapted to communicate with independent vehicle diagnostic transmitter.

FIG. 6 illustrates an exemplary system for passing data from the application to central repository.

FIG. 7 illustrates an alternative method for disabling one or more functions in a vehicle responsive phone.

### DETAILED DESCRIPTION OF DRAWINGS

For the purpose of promoting an understanding of the present invention, references are made in the text to exemplary embodiments of a device for regulating mobile communications only some of which are described herein. It should be understood that no limitations on the scope of the invention are intended by describing these exemplary embodiments. One of ordinary skill in the art will readily appreciate that modifications, such as the dimensions of a device for regulating mobile communications, are alternate but functionally similar material(s) from which the device for regulating mobile communications is made. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related. For example, one embodiment of the apparatus and system for limiting the use of mobile communication as disclosed herein may have a range of embodiments and functionality.

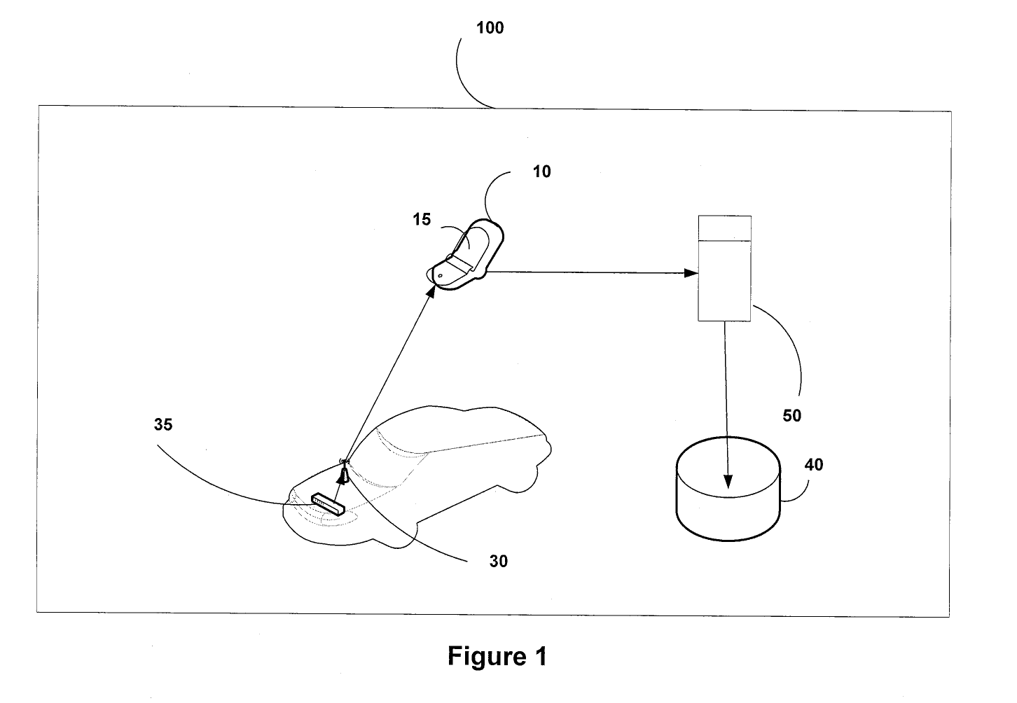

FIG. 1 shows an exemplary communication management system 100 including a vehicle responsive phone 10, a vehicle diagnostic device transceiver 30, a vehicle diagnostic device 35, a central data repository 40, and a communication management interface 50.

In the embodiment shown vehicle responsive phone 10 may be a cell phone configured to implement a plurality of communication functions, such as text messaging, internet access, and e-mail. Although a single vehicle responsive phone 10 is shown and described herein, it should be understood that system 100 may be configured to implement the functions described herein for any number of devices within a vehicle. Vehicle responsive phone 10 may be configured to use a wireless protocol such as Bluetooth™ to communicate with a vehicle diagnostic device or a device in communication with a vehicle diagnostic device that is also configured to use a wireless protocol. Although Bluetooth is described, any communication protocol may be used to communicate data between vehicle diagnostic device 35, transceiver 30, and vehicle responsive phone 10. In the embodiment shown, system 100 includes a receiver/transmitter component, transceiver 30, which receives OBD data from vehicle diagnostic device 25 and transmits vehicle diagnostic information to the vehicle responsive phone 10.

Vehicle responsive phone 10 may be configured to include communication blocking software 15. Communication blocking software 15 may be any software implemented on phone 10 configured to receive the diagnostic data from device 35, to interpret the data to determine if the state of vehicle correlates to a state where one or more functions of the phone 10 should be disabled. Software 15 may be configured to disable one or more functions of the phone 10 through any of a variety of phone control commands, including, but not limited to operating system commands, direct phone commands using APIs, communication services provider commands, etc. as described in further detail hereinbelow.

In the embodiment shown, vehicle diagnostic device 35 is an engine control module. An engine control module is an electronic control unit configured to control various aspects of an internal combustion engines operation. In still other embodiments, vehicle diagnostic device 35 may be an OBD device, an engine control module, a global positioning system (GPS) attached or embedded in the vehicle, a vehicle computing system, a vehicle monitoring system such as OnStar™, a telematic vehicle monitoring system such as those found in commercially managed fleet vehicles, and/or any other component known in the art capable of collecting or sensing vehicle data and transmitting data regarding the state of the vehicle (e.g., whether the vehicle is stopped, in motion and the speed the vehicle).

Vehicle diagnostic device 35 may provide vehicle diagnostic data in a hexadecimal or other “universal” format. Vehicle responsive phone 10 and/or communication blocking software 15 may be configured to interpret the vehicle diagnostic data in its native format.

In the embodiment shown, vehicle diagnostic device 35 communicates with the transceiver 30. In one embodiment of the invention, vehicle diagnostic device 35 may be a multi-pin output port where each pin provides data indicate a state of the vehicle and/or one or more components of the vehicle. Transceiver 30 may be configured to mate with the diagnostic device 35 to receive the information provided on one or more of the pins of device 35. Transceiver 30 may be configured to transmit the received data using a wireless communication protocol, such as the Bluetooth protocol, a cellular communication protocol, etc.

In an alternative embodiment, the present system may be configured for use in a mandated use situation, where access to system 100 and the data generated thereby is tightly controlled. For example, wherein a driver has a history of dangerous driving behavior, system 100 may be used to absolutely prohibit operation of a communication device 10 while the vehicle is moving. Vehicle responsive phone 10 may operate in conjunction with GPS technology to further monitor individual compliance (e.g., for a law enforcement program, or for persons known to be at risk for undesired driving behaviors).

According to an alternative embodiment, vehicle diagnostic device 35 may include an integral wireless communication component (not shown). Where vehicle diagnostic device 35 includes an embedded wireless communication component, system 100 may be implemented without including the stand alone transceiver 30. Advantageously, a vehicle diagnostic device 35 having an integrated wireless communication system minimizes tampering since the wireless communication component cannot be easily plugged and unplugged in the vehicle, as would be the case with on OBD reader embodiment.

In the embodiment shown in FIG. 1, system 100 further includes a central data repository 40 configured to receive and store data from vehicle responsive phone 10. Central data repository 40 may receive and store data including, but not limited to, driving history, times and speeds at which a driver operates a car, a history of enablement or disablement of software loaded on a vehicle diagnostic device, enablement and disablement of phone features, demographic data about a user's identity and location, calling activity, data describing the collaboration between vehicle speed and user activity, locations of the vehicle, vehicle malfunction and maintenance data, call identification, content of messages, etc. Data collected in central data repository 40 may be used by third parties such as employers, parents, law enforcement agents, researchers or others to determine discounts, incentives, sanctions, etc. for behavioral or marketing purposes. For example, an insurance company may provide discounts or surcharges, an employer may maintain a driving history for company vehicle, parents may view the driving behavior of their teenage drivers, etc. Central data repository 40 may be a single or multiple databases, may be geographically distributed, and/or include any other configuration to perform the functions described herein. Data collected in central data repository 40 may be utilized by data subscription service for such data, a web-based service and may be queried and accessed by an interface using any means known in the art.

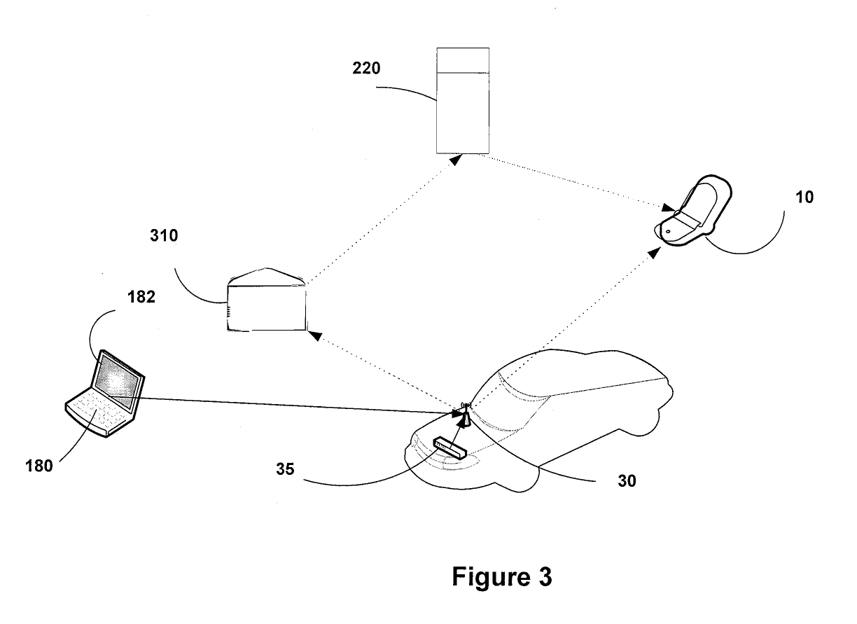

Advantageously, system 100 does not require a user to interact with a computer or download software to achieve the benefits of the functions described herein. For example, a vehicle responsive phone 10 including communication blocking software 15 pre-configured to interact with the vehicle diagnostic device 35 may be purchased. Vehicle responsive phone 10 may be a disposable apparatus configured to operate with any type of vehicle, vehicle diagnostic device 35, and transceiver 30. Further, system 100 may be configured to operate in conjunction with devices 35 that block or preclude non-enabled communication devices in a vehicle as described below with reference to FIG. 3.

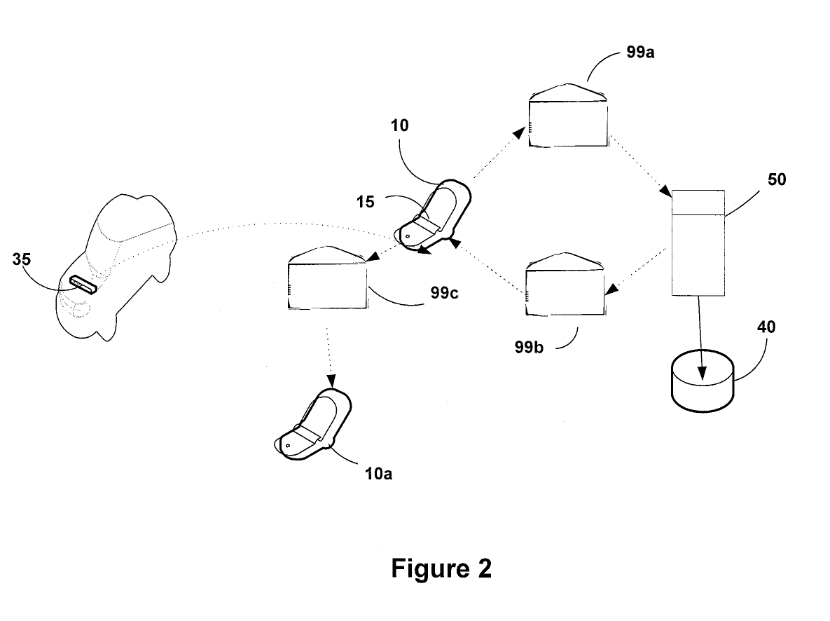

FIG. 2 illustrates an exemplary embodiment of communication system 100 including the communication management interface 50 for receiving and storing data from a vehicle responsive phone 10 to central data repository 40 and for configuring the operation of vehicle responsive phone 10, communication blocking software 15, and diagnostic device 35. Communication management interface 50 is a web interface configured to allow a user to perform a number of different functions associated with system 100 using a personal computing device. Exemplary functions may include, setting vehicle states where phone 10 should be disabled (e.g., whenever the vehicle is in gear, whenever the vehicle is in motion, when the key is in the ignition, when the vehicle is going over a certain speed, etc.), setting vehicle states where phone 10 should be re-enabled after being disabled (e.g., whenever the vehicle is in park, whenever the vehicle is stopped, when the key is removed from the ignition, when the vehicle has dropped below a certain speed, etc.), setting specific phone functions to be disabled, instantaneously disabling and/or re-enabling phone functions, viewing archived information stored in repository 40, ability to dial emergency numbers, entry of personal information that is not secured on the mobile device, etc.

Vehicle responsive phone 10 may be configured to transmit received vehicle diagnostic data in a data message 99a (via text, MMS, SMS, or any other protocol known in the art) to communication management interface 50. Communication management interface 50 monitors the state of the vehicle based on the vehicle diagnostic data. Communication management interface 50 may send a control message 99b controlling operation of the vehicle responsive phone 10 based on the received data. For example, where data message 99a includes data indicating that the vehicle is travelling at a high rate of speed, control message 99b may be configured to include instructions to vehicle responsive phone 10 to, for example, disable all communication functions, configure operation of communication blocking software 15, etc.

Communication management interface 50 may also be configured to transmit an alert message 99c based on the vehicle diagnostic data. The alert message 99c may be transmitted when the diagnostic data indicates vehicle operation that exceeds a pre-determined control parameter and may include the vehicle diagnostic data that exceeded the parameter. Alert message 99c may be sent to communication management interface 50, to another phone 10a, and/or to any other designated recipient. For example, control message 99c may be transmitted to a parent, an employer, or any other party when the vehicle exceeds a given speed, travels outside a designated area, experiences a vehicle malfunction, etc.

FIG. 3 illustrates a further embodiment in which transceiver 30 may be configured to detect the presence of a vehicle responsive phone 10, control operation of the phone 10 by interfacing directly with a communication services provider providing the communication services for phone 10. For example, transceiver 30 may be configured to detect the presence and identification information of a phone 10 whenever the phone 10 comes within wireless communication range of transceiver 30. Transceiver 30 may identify the phone based on information provided by the phone, such as a phone ID provide in response to an inquiry message, based on a Bluetooth identifier, etc. When the vehicle is in motion, or in any other communication blocking state, transceiver 30 may be configured to transmit an encrypted message 310 including the identification information directly to the communication services provider 220 to disable some or all communication services. When the vehicle stops or enters any other designated vehicle state, another message 310 may be transmitted reenabling communication services to phone 10.

Further, encrypted message 310 from transceiver 30 may be selectively configured to limit particular mobile communication device functions, including incoming telephone calls, incoming text messages, incoming pager messages, incoming e-mails, outgoing telephone messages, outgoing text messages, outgoing pager messages, outgoing e-mails, audio data and visual data for any phone within communication range. For example, vehicle responsive phone 10 may be configured to permit incoming cell phone calls from a parent and outgoing emergency calls.

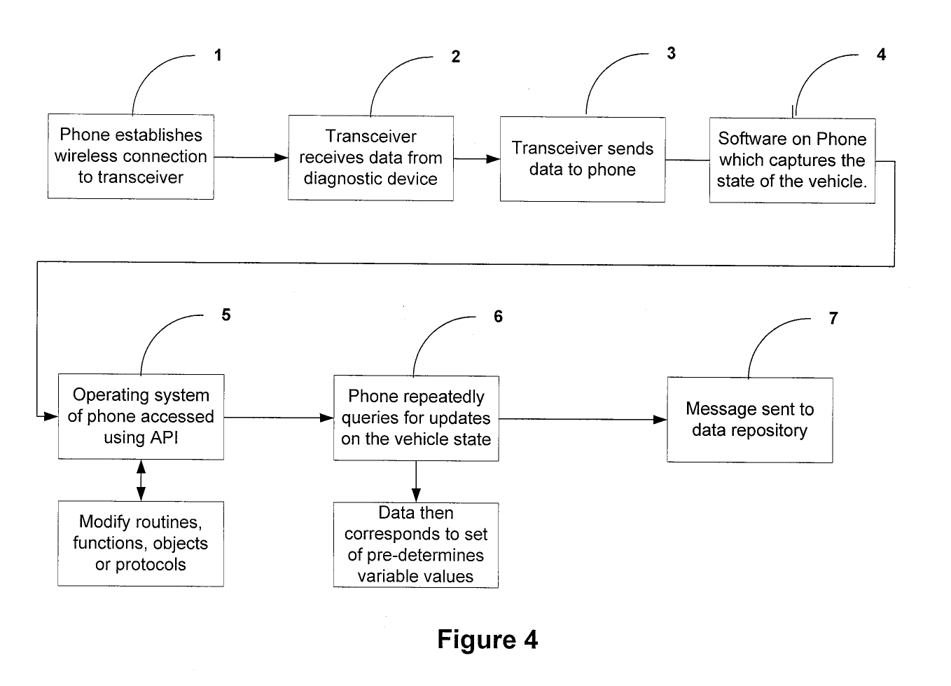

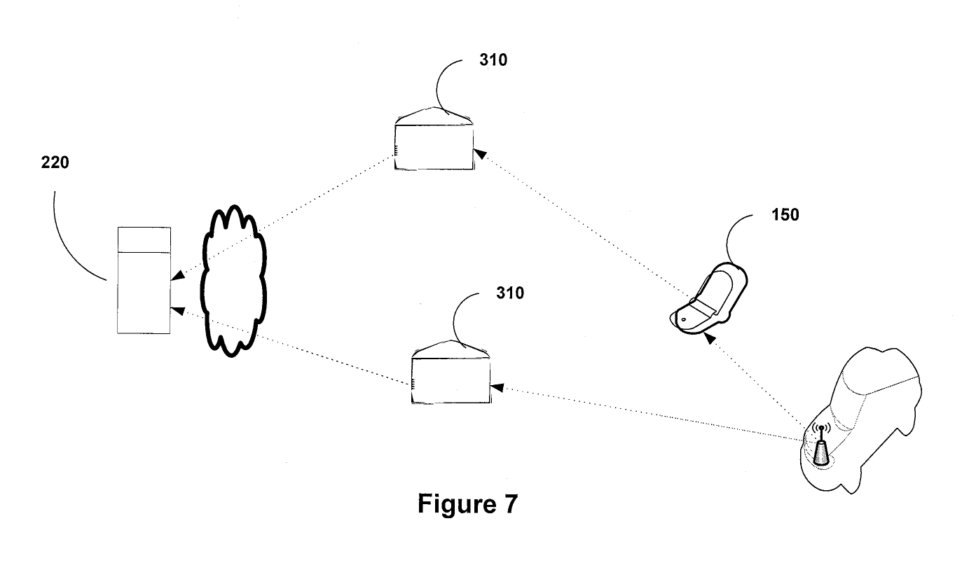

Transceiver 30 may be configured using a software interface 180 to receive a listing of phone IDs, Bluetooth IDs, vehicle states, etc. to identify which phones 10 are in proximity to the device, and to determine what information needs to be passed to the communication services provider 220 in order to enable/disable communication of the phone 10. For example, in the embodiment shown, the encrypted message 310 may be configured to disable text and e-mail functionality but to allow certain types of incoming and/or outgoing calls when a vehicle is in motion. This functionality may be implemented based on either disabling the functionality at phone 10 as shown in FIG. 4, or at a communication services provider as shown in FIGS. 3 and 7. In the embodiment shown, software interface 180 is software implemented on a computer 182 which is used to configure vehicle diagnostic device transceiver 30 with various permissions and instructions when a vehicle has reached a specific state.

Although shown and described as being implemented using transceiver 30, the system and method described with reference to FIG. 3 may be implemented by vehicle diagnostic device 35 where device 35 is configured to include an integral wireless communication device as described above with reference to FIG. 1.

FIG. 4 illustrates an exemplary method for configuring vehicle responsive phone 10 to receive and respond to vehicle diagnostic data to disable mobile communication device functionality.

In a step 1, vehicle responsive phone 10 establishes a connection with vehicle diagnostic device transceiver 30 using a wireless protocol. In the embodiment shown, the wireless protocol is Bluetooth™, but the wireless protocol may be any wireless protocol.

In a step 2, the transceiver 30 receives data from vehicle diagnostic device 35. In the embodiment shown, data transmitted by vehicle diagnostic device 35 is in hexadecimal or universal communications protocol format.

In a step 3, transceiver 30 transmits data conveying the state of a vehicle to vehicle responsive phone 10 in a hexadecimal or universal communications protocol or in any other other format which may be received and processed by vehicle responsive phone 10. Phone 10 may be configured to convert the received data to a communication format which may be read by the cell phone protocol and/or API. For example, phone 10 may be configured to include a lookup table configured to convert diagnostic data from multiple device manufacturers, device types, etc. into a single or one of a defined number of vehicle states variables

In a step 4, a vehicle state variable is created by software on vehicle responsive phone 10 which captures the state of the vehicle (“vehicle state variable”). Phone 10 may created the vehicle state variable based on the received data to have an associated variable value. For example, phone 10 may be configured to convert an engine RPM value and current gear value into a single vehicle speed variable having a value that corresponds to the current vehicle speed based on those inputs.

In a step 5, communication blocking software 15 will control the operation of phone 10 based on the vehicle state variable. For example, the operating system of the vehicle responsive phone 10 may be accessed to switch off all communication function (similar to the “Airplane mode” found in many smartphones). Alternatively, where phone 10 is not a smartphone, the operating system does not allow external controls, etc., software 15 may be configured to utilize Application Programming Interface (API) commands for the vehicle responsive phone to modify routines, functions, data structures, objects, protocols, etc. directly.

Operating system 15 may be configured to include a first option to disable the phone using the operating system, a second option to disable the phone using APIs associated with the phone, and a third option to disable the phone by communicating directly with the communication services provider 220 for the phone, each option being implemented as described herein. The API's that are called may be implemented by either the Network Provider, the Device Manufacturer, or a third party provider (e.g. Blackberry, Microsoft Mobile, Apple iPhone, etc.). Functions which may be called and/or modified by the API include, but are not limited to, voice, data, text, graphics, keyboard or any other functions needed to limit mobile phone usage based on rules built into the application. If the functionality to disable the device for that mobile device model and operating system does not reside in the Operating System, the software 15 queries the API's of the mobile device itself. These are lower level functions used to control functions on the device that the Operating System does not control. Because each mobile device and Operating System is proprietary, phone 10 may not include pre-defined rules as to whether the disabling functionality will require the code to access the Operating System API's, Device Manufacturer's API's, or code embedded directly on the chipset of the mobile device, requiring the redundancy described herein.

In a step 6, after at least some communication functions have been disabled, vehicle responsive phone 10 may be configured to repeatedly query transceiver 30 for updates on the vehicles state. Once data received from vehicle diagnostic device 35 indicates that the vehicle has dropped below an established threshold value associated with a pre-determined control parameter (e.g., indicating that the vehicle is no longer in motion), the software 15 is configured to reactivate phone functionality.

In a step 7, vehicle responsive phone 10 sends a message to the data repository 40 containing log data for the session. One or more messages may be sent to a data repository 40, data tracking and processing server, and/or any other repository, cellular phone or other desination.

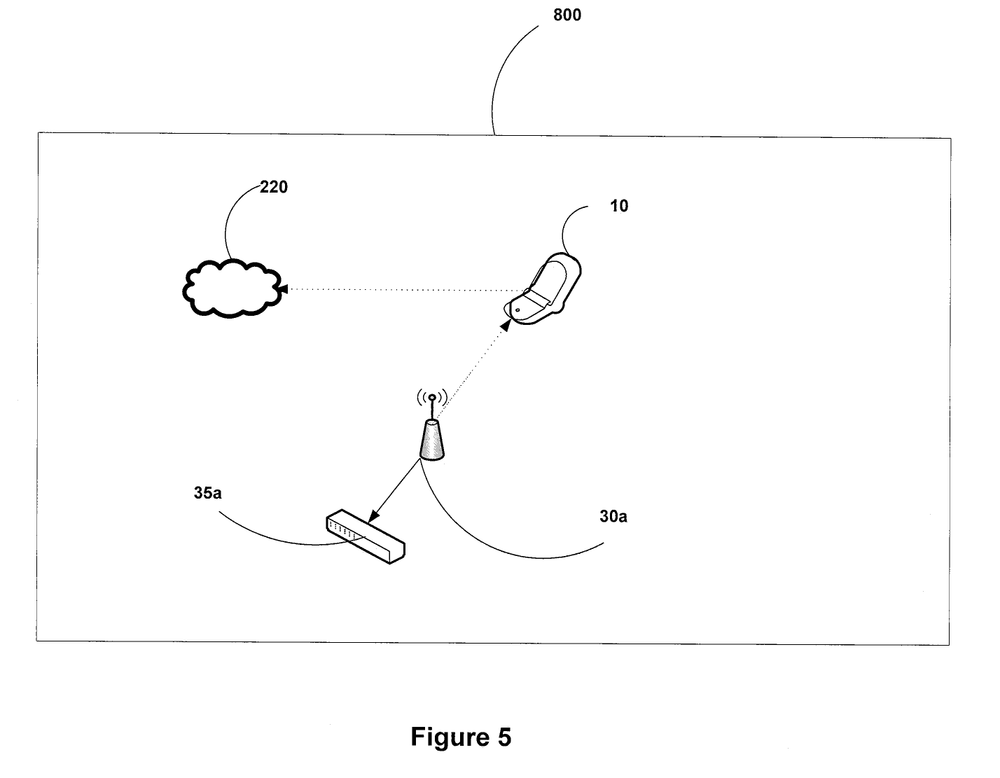

FIG. 5 illustrates an embodiment of mobile communication device system 800 which is adapted to communicate with an integrated vehicle diagnostic transceiver 30a. In the embodiment shown, the integrated vehicle diagnostic transceiver 30a, transmits vehicle diagnostic data to the vehicle responsive phone 10 without using an OBD port. Various embodiments of mobile communication device system may include or omit integrated vehicle diagnostic device 35A.

In other embodiments vehicle diagnostic data (e.g., vehicle motion, vehicle key in ignition, vehicle is in gear, location data, etc.) can be passed to the vehicle responsive phone 10 directly. In various embodiments, vehicle diagnostic data may be transmitted to the vehicle responsive phone 10 via any universally accepted communications protocol, including the communication services provider 220. Once API permissions are authorized on the vehicle responsive phone 10 or the communication services provider 220, then the mobile device can be limited the same as if the diagnostic data was coming from the stand alone vehicle diagnostic transceiver 30.

According to an exemplary embodiment, system 100 may be implemented as a component in a fleet vehicle management system where all fleet vehicles include onboard GPS systems. The onboard GPS systems may be configured to include an embedded transceiver 30a as shown in FIG. 5, or may be configured to use a vehicle responsive phone 10 as described elsewhere in the current application. GPS data may be used to determine vehicle speed, location, etc. for controlling the enabling/disabling of communication functions for a vehicle responsive phone 10.

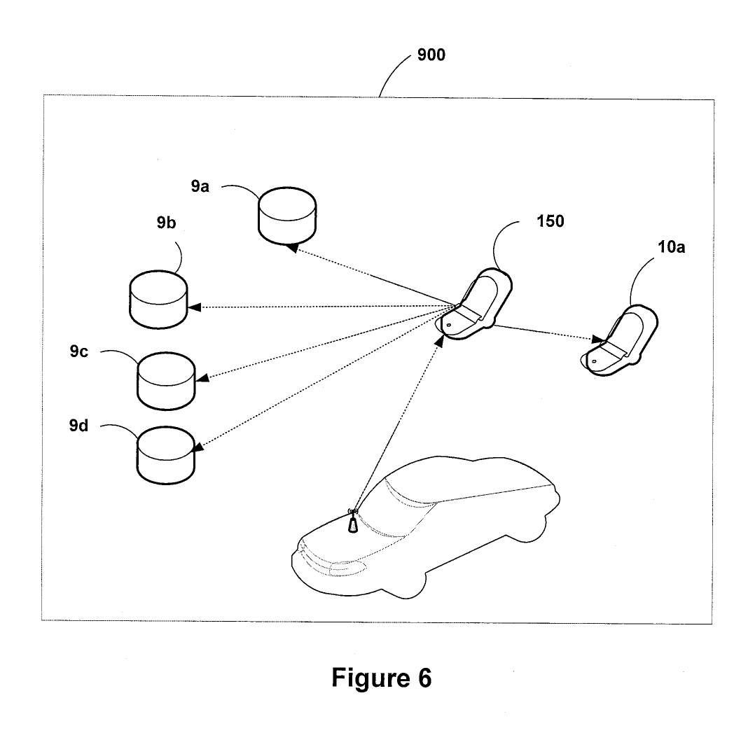

FIG. 6 illustrates an exemplary system 900 for passing data from the application to multiple central repositories simultaneously. In the exemplary embodiment shown, data is passed to insurance company repository 9a, mobile service repository 9b, employer repository 9c, revenue processing repository 9d, and/or another mobile communications device 10a simultaneously. In the embodiment shown, central repositories 9a, 9b, and 9c are remote computers configured with software which maintains data about a user and/or usage of a vehicle responsive phone 10 enabled to receive OBD data. Mobile communication device 150 may utilize virtually any communication protocol known in the art (e.g., PAN, texting, any phone messaging, emailing, etc.) to the mobile communication device can be used to route data to a central repository or another mobile communications device 10. An example of this functionality could be that usage data gets passed to an insurance provider, but speed data does not go to a central repository, but instead gets passed to a patent's mobile phone.

FIG. 7 illustrates an exemplary embodiment in which an encrypted message 310 is sent from the vehicle responsive phone 10 to a mobile communication service provider 220. Encrypted text 310 contains an ‘on/off’ indicator and an identifier for the vehicle response phone. Message 310 may be transmitted based on data from the vehicle responsive phone 10 which would indicate that the vehicle is or is not in motion and may further request that the mobile communication service provider 220 activates or de-activates mobile communication services based on the message 310. According to an alternative embodiment, such as that described in FIG. 3, transceiver 30 and/or diagnostic device 35 may be embedded with a mobile transmitter that sends message 310 to the mobile phone provider 220 when it recognizes that the vehicle is in motion, and that a vehicle responsive phone 10 is within bluetooth distance.

What is claimed is:

1. A system for regulating use of mobile communication functions while driving, comprising:
a vehicle diagnostic device configured to generate vehicle diagnostic data indicating a current state of a vehicle;
a vehicle diagnostic information port configured to provide the vehicle diagnostic data;
a transceiver configured to plug into the vehicle diagnostic information port and transmit the vehicle diagnostic data using a wireless communication protocol; and
a vehicle responsive phone including communication blocking software configured to receive the vehicle diagnostic data and to terminate the operation of at least one function of the vehicle responsive phone based on the received vehicle diagnostic data.

2. The system of claim 1 wherein the vehicle diagnostic information port is an OBD port and wherein the transceiver is a component of an OBD reader configured to plug into the OBD port.

3. The system of claim 1 wherein terminating the operation of at least one function of the vehicle responsive phone said vehicle state variable includes disabling all communication functions for the vehicle responsive phone.

4. The system of claim 1 wherein the at least one communication function is selected from a group consisting of incoming telephone calls, incoming text messages, incoming pager messages, incoming e-mails, outgoing telephone calls, outgoing text messages, outgoing pager messages, outgoing e-mails, audio data and visual data.

5. The system of claim 1 further including at least one central data repository wherein the vehicle responsive phone is configured to transmit the vehicle diagnostic data to the central data repository and the central data repository is configured to generate a report including the vehicle diagnostic data transmitted by the vehicle responsive phone.

6. The system of claim 5 wherein the generated report includes a summary of driving behavior.

7. The system of claim 1, wherein the communication blocking software is configured to terminate the operation of at least one function of the vehicle responsive phone based on a comparison of the vehicle diagnostic data to a pre-configured threshold value.

8. The system of claim 1 wherein the vehicle diagnostic device is a global positioning system.

9. A system for regulating use of mobile communication functions while driving, comprising:
a vehicle diagnostic device configured to generate vehicle diagnostic data indicating a current state of a vehicle, the vehicle diagnostic device including a transceiver configured to transmit the vehicle diagnostic data using a wireless communication protocol; and
a vehicle responsive phone including communication blocking software configured to receive the vehicle diagnostic data and to terminate the operation of at least one function of the vehicle responsive phone based on the received vehicle diagnostic data.

10. The system of claim 9 wherein the vehicle responsive phone is further configured to transmit a message including to the vehicle diagnostic data to a second phone.

11. The system of claim 9 wherein terminating the operation of at least one function of the vehicle responsive phone said vehicle state variable includes disabling all communication functions for the vehicle responsive phone.

12. The system of claim 9 wherein the at least one communication function is selected from a group consisting of incoming telephone calls, incoming text messages, incoming pager messages, incoming e-mails, outgoing telephone calls, outgoing text messages, outgoing pager messages, outgoing e-mails, audio data and visual data.

13. The system of claim 9 further including at least one central data repository wherein the vehicle responsive phone is configured to transmit the vehicle diagnostic data to the central data repository and the central data repository is configured to generate a report including the vehicle diagnostic data transmitted by the vehicle responsive phone.

14. The system of claim 13 wherein the generated report includes a summary of driving behavior.

15. The system of claim 9, wherein the communication blocking software is configured to terminate the operation of at least one function of the vehicle responsive phone based on a comparison of the vehicle diagnostic data to a pre-configured threshold value.

16. The system of claim 9 wherein the vehicle diagnostic device is a global positioning system.

17. A system for regulating use of mobile communication functions while driving comprised of:
a vehicle diagnostic device configured to generate vehicle diagnostic data indicating a current state of a vehicle;
a vehicle diagnostic information port configured to provide the vehicle diagnostic data;
a transceiver configured to plug into the vehicle diagnostic information port and transmit the vehicle diagnostic data using a wireless communication protocol; and
a vehicle responsive phone including communication blocking software configured to receive the vehicle diagnostic data and to generate and transmit a disable communication message to a communication services provider associated with the vehicle responsive phone, the message being transmitted based on the received vehicle diagnostic data, the disable communication message including a vehicle responsive phone identifier.

18. The system of claim 17 wherein the vehicle diagnostic device is a global positioning system.

19. The system of claim 17 wherein the vehicle responsive phone is further configured to transmit a message including to the vehicle diagnostic data to a second phone.

20. A system for regulating use of mobile communication functions while driving comprised of:
a vehicle diagnostic device that generate vehicle diagnostic data indicating a current state of a vehicle;
a vehicle diagnostic information port configured to provide the vehicle diagnostic data; and
a communication management transceiver configured to plug into the vehicle diagnostic information port, the transceiver configured to:
detect a vehicle responsive phone including a vehicle responsive phone identifier, and
transmit an enable/disable communication message to a communication services provider associated with the vehicle responsive phone based on the received vehicle diagnostic data, the disable communication message including a vehicle responsive phone identifier.

21. The system of claim 20 wherein the vehicle diagnostic information port is an OBD port and wherein the transceiver is a component of an OBD reader configured to plug into the OBD port.

22. The system of claim 20 wherein terminating the operation of at least one function of the vehicle responsive phone said vehicle state variable includes disabling all communication functions for the vehicle responsive phone.

23. The system of claim 20 wherein the at least one communication function is selected from a group consisting of incoming telephone calls, incoming text messages, incoming pager messages, incoming e-mails, outgoing telephone calls, outgoing text messages, outgoing pager messages, outgoing e-mails, audio data and visual data.

24. The system of claim 20 further including at least one central data repository wherein the vehicle responsive phone is configured to transmit the vehicle diagnostic data to the central data repository and the central data repository is configured to generate a report including the vehicle diagnostic data transmitted by the vehicle responsive phone.

25. The system of claim 24 wherein the generated report includes a summary of driving behavior.

26. The system of claim 20 wherein the vehicle diagnostic device is a global positioning system.

27. The system of claim 20, wherein the communication blocking software is configured to terminate the operation of at least one function of the vehicle responsive phone based on a comparison of the vehicle diagnostic data to a pre-configured threshold value.
